(19) United States
(12) Patent Application Publication
(10) Pub. No.: US 2005/0217950 A1
(43) Pub. Date: Oct. 6, 2005

(54) Lightweight reinforced brake drum and method for making same

(75) Inventors: Dallas W. Jolley JR., University Place, WA (US); Charles Benjamin Rau III, Gig Harbor, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Benmaxx, LLC, University Place, WA (US)

(21) Appl. No.: 11/078,218

(22) Filed: Mar. 11, 2005

Related U.S. Application Data
(60) Provisional application No. 60/646,311, filed on Jan. 21, 2005.
(60) Provisional application No. 60/611,642, filed on Sep. 20, 2004.
(60) Provisional application No. 60/552,242, filed on Mar. 11, 2004.

(51) Int. Cl. F16D 65/10

(52) U.S. Cl. 188/218 R

(57) ABSTRACT

The invention provides a lightweight brake drum (10) comprising a lightweight, tubular inner member (14) having a reinforcement wrapping retention pattern (e.g., groove) cast in the exterior surface thereof, a length of reinforcement material (e.g., wrapped wire, cable, mesh, fibers, etc.) (16) in communication with a reinforcement retention pattern (e.g., a groove around the inner member) (14), the drum including an outer shell (18). The inner member (14) and the outer shell (18) are made of lightweight materials. Single, or multiple layers of reinforcement material (e.g. wrapping) are applied (e.g., wrapped) around the inner member (14) to support and inhibit expansion of the inner member (14). Because the reinforcement material (16) provides support against expansion, the inner member (14) and the outer shell (18) can be made of lightweight materials. In preferred embodiments, a bonding layer (66) is applied to the exterior surface of the inner member prior to application of the reinforcement material thereon. In preferred embodiments the reinforcement material comprises a low-impedance material such as copper along with another material that has good tensile strength characteristics (e.g., steel, composite fibers, Basalt-fibers, etc.). Preferably, the inner member comprises at least one material selected from the group consisting of a aluminum-based metal matrix composite (MMC) with a particulate reinforcement, ceramic matrix composite (CMC), and carbon graphite foam.

### FIELD OF THE INVENTION

This invention relates generally to the field of brake drums for motor vehicles, and specifically to the field of lightweight brake drums.

### BACKGROUND

Brake shoe and brake drum-type brakes have been used on motor vehicles for many years. While many automobiles now use disc-type brakes, brake shoe and brake drum-type brakes are still used in many automobiles, and especially for braking the rear wheels in almost all heavy duty trucks (e.g., class 8), and medium duty trucks (e.g., class 7).

The weight of a motor vehicle's brake drums has become increasingly more important to the vehicle manufacturer and to the vehicle operator. Primarily, the weight of the vehicle's brake drums affects the mileage efficiency of the vehicle, and this factor is becoming increasingly important to the manufacturers of automobiles sold in the United States and elsewhere. The Federal Government wishes to provide incentives for automobile manufacturers to continuously increase the mileage efficiency of their automobile line. Automobile manufacturers are diligently searching for ways to reduce the weight requirements on even the smallest automobile and truck components.

The weight of brake drums is very important to truck manufacturers. The weight of a truck's brake drum not only affects the truck's mileage efficiency but also directly affects the amount of cargo which can be transported by a truck. This stems from the fact that governmental regulations strictly limit the gross weight of all commercial vehicles. Thus, any savings in the weight of a commercial vehicle allows the owner of that vehicle to carry a like quantity of additional weight. In the highly competitive trucking industry, the total quantity of freight that can be transported per load is critical to profitability.

Conventional brake drums are manufactured from ductile iron, cast iron or steel. A typical large truck brake drum weighs about 120 pounds. Attempts have been made to reduce this weight by manufacturing the drums from lighter materials, such as aluminum and aluminum alloys. However, the use of lighter materials (e.g., aluminum and aluminum alloys, such as ‘319’ or ‘356’) is restricted by strength requirements. For example, a typical truck brake drum must have an internal yield strength in excess of 40,000 psi. Brake drums constructed from aluminum and aluminum alloys alone do not have this high of an internal yield strength.

In an attempt to take advantage of lightweight materials while retaining adequate strength requirements, several attempts have been made to use brake drums made of a combination of lightweight and heavier materials. For example, in U.S. Pat. No. 1,989,211, a bimetallic brake drum is proposed that comprises a cast aluminum housing in combination with a steel internal liner. The resulting brake drum is lighter than conventional brake drums and has sufficient internal yield strength. However, such a drum is yet not sufficiently satisfactory. The steel liner must still be fairly thick to provide for adequate wear life, and for truck brake drums, the steel liner must be at least ⅜ of an inch thick to obtain sufficient internal yield strength. This means the brake drum remains relatively heavy. Additionally, the internal liner has a strong tendency to slip within the outer housing. This requires that the liner:housing interface be provided with transverse ridges or spines to lock the liner within the housing. (see e.g., U.S. Pat. No. 1,989,211). In practice, this generally means that the housing and liner must be cast together.

Another concern with such composite drums is the lack of efficient heat transfer between the liner and the outer drum, because of the inevitable interface created between the material. Adequate heat transfer is important to keep the brakes cool under, particular under heavy load and demand conditions (e.g., medium and heavy duty trucks).

Brake drums and brake discs have been homogeneously fabricated from aluminum-based metal matrix composite (MMC), comprising silicon carbide particulate reinforcement. Such aluminum MMC provides for reduced weight, improved mechanical and thermal properties relative to aluminum and aluminum alloys, and is commercially available, for example, under the name DURALCAN® (Alcan Aluminum Limited). However, there are significant disadvantages with such homogeneous MMC castings. MMC casting are expensive relative to iron and conventional aluminum alloys. Additionally, compared to iron and conventional aluminum castings, aluminum MMC castings are relatively difficult to machine because of the silicon particulate reinforcement.

Accordingly, there is a need for a lightweight brake drum which is even lighter than the bimetallic lightweight brake drums of the prior art, a brake drum for which stability does not depend on cast ridges or spines that interface between the housing and the liner, and a brake drum which does not require dissimilar brake drum components to be cast in a single operation. There is also a need in the art for a brake drum with improved thermal and acoustical behavior. There is further need in the art to incorporate sensor devices, sensor materials or other materials such as heat transfer enhancing materials to enhance performance, monitoring, maintenance or utility life of brake drums and systems. There is a pronounced need in the art for additional means to provide secondary braking means (e.g., improved drag-type brakes) in the trucking industry.

### SUMMARY OF THE INVENTION

Embodiments of the present invention are directed to a brake drum which meets the above-described needs. In one embodiment, the brake drum includes a tubular inner member (wear liner) having an interior surface suitable for contacting a brake pad and an exterior surface, a length of reinforcement wrapping (e.g., wire, cable, array (mesh), etc.) snugly wrapped around a portion of the exterior surface of the wear liner, and at least one fastener for securing at least a portion of a wheel assembly to the brake drum. Preferably, the brake drum includes a tubular outer shell molded over and substantially covering the length of reinforcement wrapping to protect the wrapping and provide additional support to the brake drum.

As described in detail below, the length of reinforcement wrapping (e.g., single strand, cable, mesh etc.) wrapped around the tubular inner member supports (strengthens) the inner member. Thus, the inner member and the outer shell of the brake drum can be made from similar, lightweight materials having lower internal yield strengths than the prior art steel brake drums. The term ‘internal yield strength’ as used in this application means the amount of internal pressure which the brake drum can withstand without failing.

Further, since the inner member and the outer shell can be made of similar materials with similar rates of thermal expansion, and the outer shell can be molded over the reinforcement wrapping, there is no need for ridges or cast spines to interface between the inner member (wear liner) and the outer shell.

In particular embodiments, multiple layers of the length of reinforcement wrapping are wrapped around substantially the entire exterior surface to support the entire inner member. Preferably, where the wrapping is, for example, wire, the length of wire has a diameter of between about 0.1 inches and about 0.4 inches, has a tensile strength of at least 180,000 psi, and is wrapped at a tension of at least about 25 foot-pounds to provide tight, consistent wrapping of the length of wire around the exterior surface and sufficient support of the inner member. Alternatively, pre-tensioned wrapped multi-strand wire (e.g., cable) can be used for this purpose. Preferably, cable is used. Preferably, a single layer of cable winding is used.

In alternative preferred embodiments, the length of reinforcement wrapping comprises high-strength fibers, such as composite fibers, cable or mesh, including, but not limited to fibers, cables and arrays (e.g., mesh) comprising: carbon fibers, vitreous glass fibers (Basalt wool, comprising SiO₂, AI₂O₃, CaO, MgO and Fe₂O₃), alumina oxide fibers and e-glass (e.g., fiber glass), and combinations thereof. According to the present invention such fibers are used in, for example, wire, cable, and other arrays (e.g., mesh, or woven arrays) to provide reinforcement wrapping to support the inner member. Preferably, the reinforcement wrapping comprises material that is not flammable, and is not irritating to the eyes, skin and respiratory tract. Preferably, the fibers of the reinforcement wrapping are non-respirable, and non-hazardous. Preferably, reinforcement wrapping comprises vitreous glass (Basalt wool). Preferably, the vitreous fibers are amorphous comprising, as main constituents, SiO₂, Al₂O₃, CaO, MgO and Fe₂O₃, and no carcinogens are present in amounts above 0.1%. Preferably, the vitreous glass melts at about 2400 degrees Fahrenheit.

Since the length of reinforcement wrapping supports the inner member and inhibits expansion of the inner member, the inner member and the outer shell can be made from lightweight materials having a density of less than about 0.15 pounds per cubic inch, such as aluminum and aluminum alloys. For example, the inner member can be made of an alloy which includes at least about seventy-five (75) volume percent aluminum and between about ten percent (10%) and about twenty-five percent (25%) abrasive material so that the brake pads can grip against the brake drum. In alternative preferred embodiments, the percentage of abrasive material is at least 10%. Preferably the percentage of abrasive material is between about 10% and about 50%, or between about 10% and about 30%, or between about 10% and about 28%, or between about 15% and about 28%. Preferably, mixed metal composite (MMC), or ceramic metal composite (CMC) is used to form the inner member (wear plate).

A preferred embodiment of the invention comprises a generally continuous, circular, (e.g., helical) wire alignment groove cast into the outer surface of the inner member. Preferably, the groove is in the shape of a uniform helix. Alternatively, circular or spiral grooves with non-uniform pitch could be substituted for the generally circular, uniform helical groove. The cast groove has two ends. The groove is shaped such that the wire or cable fits snugly within the groove. The cast grooves comprise ‘walls’ of inner member material that separate the groove troughs. By welding the wire to the inner member at each end of the groove, it is possible to create a single-layer wire (preferably cable) wrapping covering a substantial portion of the exterior surface of the inner member.

The cast alignment groove facilitates keeping the wire in a fixed position relative to the inner member. By varying the pitch of the groove relative to a facial plane of the inner member, or by changing how tightly the groove is wound, it is possible to use wires or cables of different length to substantially cover the exterior surface of the inner member.

In other embodiments comprising an inner member with a cast alignment groove, multiple layers of wire are wrapped around the inner member with the first layer of wire fitting within the grove and later layers crossing (e.g., criss-crossing) over previous layers. By welding the ends of the wire to the inner member or the wire, the wire can be held at a constant tension, covers a substantial portion of the exterior surface of the inner member, and provides rigidity and strength to the inner member.

In particularly preferred embodiments, at least one of the tubular inner member, the bonding layer, and the outer shell comprises ‘carbon graphite foam’. Preferably, infusion casting is used in such embodiments. For example, an aluminum-based alloys (e.g., eutecic, hypereutectic, or otherwise), with or without particulate reinforcement are cast into (e.g., infiltration casting) a ‘preform’ of porous ‘carbon graphite foam’ (with or without particulate reinforcement, such as silicon carbide). Carbon graphite foam (developed at Oak Ridge National Laboratory, USA) has high thermal conductivity and also acts as super-conductor (see, e.g., U.S. Pat. Nos. 6,673,328, 6,663,842, 6,656,443, 6,398,994, 6,387,343 and 6,261,485, all of which are incorporated by reference herein in their entirety). Preferably the silicon carbide volume should be from about 10% to 35% to provide desired friction at wear plate rubbing surface. Infiltration of un-reinforced or reinforced alloy into carbon graphite foam ‘preform’ is during a suitable casting procedure including, but not limited to die casting, high-vacuum permanent mold casting, squeeze casting, or centrifugal casting. According to the present invention, carbon graphite foam can be included in the compositions of at least one of the tubular inner member, and any bonding layers, or other member or parts in contact therewith. Significantly, according to the present invention, inner members comprised of carbon graphite foam are more cost effective that CMC versions, and are environmentally favored because they are produced from a by-product of coal production.

In alternative embodiments with reinforcement wrapping comprising fiber arrays (e.g., carbon fibers, vitreous glass fibers (Basalt wool comprising SiO₂, AI₂O₃, CaO, MgO and Fe₂O₃), alumina oxide fibers and e-glass (e.g., fiber glass), and combinations thereof), the outer surface of the inner member may have a suitable alignment pattern cast into the outer surface thereof to facilitate keeping the fiber arrays in a fixed position relative to the inner member.

Additional embodiments comprise sensor materials or devices (e.g., magnetic resistive devices, or thermal transfer materials such as sodium metal) placed in recessed cavities in the walls formed by the generally continuous, circular, helical groove on the outer surface of the inner member, or placed in recessed cavities in the outer surface of the inner member that are positioned in areas not covered by the groove.

Particular embodiments of the invention include a bonding layer between the exterior surface of the inner member (including over the reinforcement wrapping) and the outer shell. Preferably the inner member and the outer shell are made of conventional aluminum, aluminum alloy, or an aluminum-based metal matrix composite (MMC), comprising a particulate reinforcement (e.g., DURALCAN®, containing silicon carbide; manufactured by Alcan Aluminum Limited). Preferably, the outer shell and the inner member comprise at least one member of the 535-alloy family (ALCAN aluminum) selected from the group consisting of 535.0, 535.2, A535.0, A535.1, B535.0, B535.2. Preferably, an essentially Be (beryllium)-free alloy, such as A535 and B535 (low Mn) are used. Preferably, A535.1 is used. Alternatively, the inner member consists of, or comprises ceramic matrix composite (CMC); ‘carbon graphite foam’; or manganese-bronze having a particulate reinforcement such as, but not limited to silicon carbide (e.g., from about 10% to about 35%).

Preferably, the bonding layer comprises a metal alloy (e.g., 1100 aluminum) having a melting temperature lower than that of either the material from which the inner member and the outer shell are made of or the material from which the wire is made of, and is fused between the wire wrapped around the inner member and the outer shell. Preferably, the bonding layer is applied by flame spraying. Preferably the bonding layer is applied to the exterior surface of the inner member (including over the cast grooves), prior to wrapping of the wire or cable into the grooves. Alternatively bonding layers are applied to the exterior surface of the inner members, both before and after wrapping of the wire or cable.

Preferably, for bonding layers comprising 1100 aluminum and the like, the bonding layer also comprises an amount of zinc or tin suitable to confer enhanced bonding (most likely by lowering the melting temperature of the bonding layer). In alternative embodiments, the boding layer is an adhesive (e.g., high-temperature adhesive). Preferably, such adhesives are used in combination with, for example, ceramic matrix composite (CMC) wear plates. Preferably, the bonding layers, whether fused aluminum based or high-temperature adhesive comprise one or more additional materials to enhance thermal conduction. Preferably, the material comprises ‘carbon graphite foam.’

Yet further embodiments provide a method for making a brake drum. The method includes manufacturing a tubular inner member and wrapping a length of reinforcement wrapping (e.g., wire, cable, fiber array (mesh)) tightly around an exterior surface of the tubular inner member. In preferred embodiments the inner member comprises or consists of MMC.

The method also can include molding (e.g., casting) an outer shell that substantially or completely covers the length of wire around the exterior surface to provide additional support to the brake drum. Preferably an alignment groove is cast into the exterior surface of the inner member, for alignment of the wrapped wire.

In particular embodiments, the MMC inner member is initially cast as MMC.

In alternative preferred embodiments, the MMC inner member is provided by infiltration casting of molten aluminum alloy (the outer shell material) into a porous preform positioned within a die cast mold cavity for in situ casting. Preferably, the porous perform comprises or consists of silicon carbide and/or aluminum oxide that has been cast to form the porous preform. Preferably, the porous perform has the dimensions of the inner member, and has a porosity percentage of about 72% (corresponding to a particle percentage of about 28% in the final MMC inner member). Alternatively, the porosity percentage can vary between about 75% and about 50% (corresponding to a particle percentage of about 25% to about 50% in the final MMC inner member).

In particular embodiments, the method of making the brake drum can incorporate an intermediate stage. After manufacturing a tubular inner member (by either direct MMC casting or using the above-described perform approach) and wrapping a length of wire or cable tightly around an exterior surface of the tubular inner member, a bonding layer comprising a metal alloy (e.g., 1100 aluminum) can be sprayed over the wire wrapping. The method can also include molding an outer shell that substantially covers the length of wire around the exterior surface to provide additional support to the brake drum.

In an alternate embodiment, the method of making the brake drum can incorporate a bonding layer comprising a thin shell of metal alloy (e.g., 1100 aluminum) that is cast over a wire wrapping an inner tubular member. This shell bonds to the wire wrapping under the heat and pressure of molding an outer shell that substantially covers the length of wire around the exterior surface.

In embodiments where the reinforcement wrapping comprises Basalt fibers alumina oxide fibers, e-glass, composite fibers, etc., that are made into wire, cable or arrays (e.g., mesh), the reinforcement wrapping is preferably impregnated with 1100 aluminum dust to improve ‘wetting’ during the casting process.

Preferred embodiments comprise spraying, applying, dusting or casting a bonding layer of metal alloy (e.g., 1100 aluminum) over the exterior surface of the inner member (including over the optional grooves or retaining patterns thereof) before the reinforcement wrapping is wrapped around the inner member. This bonding layer bonds to the inner member and the wrapping (e.g., wire) under the heat and pressure of molding an outer shell that substantially covers the length of wire around the exterior surface.

One skilled in the art would recognize that two separate bonding layers—one between the inner member and the wire and the second between the wire wrapping and the outer shell—of metal alloy (e.g., 1100 aluminum) could also be employed. The two bonding layers are preferably of the same material in order to facilitate a stronger bond between the bonding layers as well as between the bonding layers, the inner member, the wire wrapping, and the outer shell. The two separate bonding layers would bond to each other and the other components under the heat and pressure of molding the outer shell.

In alternate embodiments, particularly those having inner members comprising or consisting of CMC, the bonding layer may comprise or consist of epoxy.

In additional preferred embodiments, a wire or cable comprising copper, or comprising one or more other low-impedance materials is used to wrap and support the inner member. Preferably, such copper-containing wire, cable or mesh also comprises another material (e.g., steel, Basalt fibers, etc.) to maintain the strength of the reinforcement wrapping. According to the present invention, such wrappings (with copper or low-impedance material) are operable to interact with external activatable magnetic elements (e.g., electromagnets), fixed at one or more positions within a vehicle (e.g., truck) so as to be in electromagnetic association with the inventive drums to provide, for example, for additional braking (drag braking) when needed.

The present invention provides a strong, lightweight brake drum which can be manufactured relatively inexpensively, because the inner member and the outer shell can be made from similar materials and there is no need for ridges and spines between the inner member since the outer shell can be molded over the wire. Additionally, the presence of the inventive bonding layer or layers provides for improved thermal and acoustic transfer between the inner member and the outer shell of the drum. The inventive drums provide for optional sensor means, and means for optional electromagnetic mediated braking (e.g., drag braking).

### BRIEF DESCRIPTION OF THE DRAWINGS

These and other features and aspects and advantages of the present invention will become better understood with reference to the following description, appended claims and accompanying drawings where:

FIG. 1 is a side plan, cut-away view of a brake drum having features of the present invention;

FIG. 2 is a perspective view of a length of wire being wrapped around an exterior surface of a tubular inner member;

FIG. 3 is a perspective view of the tubular inner member of FIG. 2 with two layers of wire wrapped around the exterior surface;

FIG. 4 is a perspective view of the tubular inner member of FIG. 2 with three layers of wire wrapped around the exterior surface;

FIG. 5 is a perspective view of the tubular inner member of FIG. 2 with four layers of wire wrapped around the exterior surface;

FIG. 6 is a side plan view of a vehicle with an enlarged, cut-away view of a wheel assembly having features of the present invention;

FIG. 7 is an enlarged, longitudinal cross-sectional view taken from line 7-7 in FIG. 6;

FIG. 8 is perspective view of the tubular inner member with a generally continuous, circular, helical groove on the outer surface;

FIG. 9 illustrates two exemplary circular helices (and pitch angles) plotted on two three-dimensional Cartesian planes;

FIG. 10 is an side plan, cut-away, exploded view of a tubular inner member with a groove and a recessed cavity, sprayed on bonding layer, one layer of wire or cable wrapped around the inner member, and the outer shell molded (e.g., cast) to cover all or substantially all of the wire wrapping;

FIG. 11 is a side plan, close-up of a tubular inner member with a groove and a recessed cavity, sprayed on bonding layer, wire wrapping, and outer shell molder to cover all or substantially all of the wire wrapping; and

FIG. 12 is an exploded view of an inner member with a groove and a recessed cavity, sprayed on bonding layer, wire wrapping, and outer shell that is molded to cover all or substantially all of the wire wrapping.

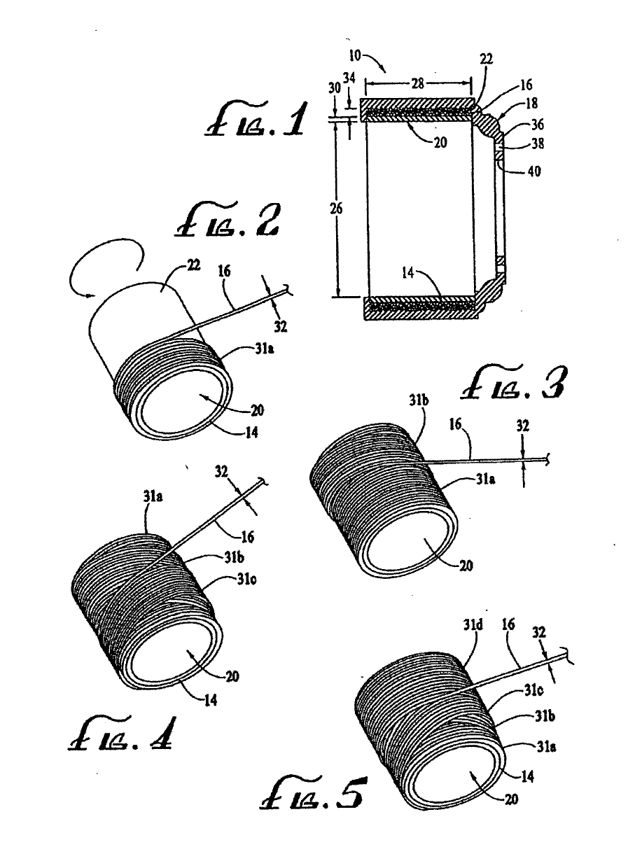

### DETAILED DESCRIPTION OF THE INVENTION

Particular embodiments of the present invention provide a novel lightweight, reinforced brake drum comprising an inner member (wear plate), a length or amount of reinforcement wrapping or material (e.g., wire, cable, fiber or mesh), and an outer shell. Preferably, the inner member comprises a generally helical groove, or other reinforcement or wrapping retention pattern or means on the exterior surface thereof. Preferably, a bonding layer is also present to enhance thermal and/or acoustical transfer. Preferably, the generally tubular inner member (wear plate) consists of or comprises at least one material selected from the group consisting of: aluminum-based metal matrix composite (MMC), comprising a particulate reinforcement; ceramic matrix composite (CMC); ‘carbon graphite foam’; or manganese-bronze having a particulate reinforcement such as, but not limited to silicon carbide (e.g., from about 10% to about 35%).

The following discussion describes in detail particular embodiments of the invention and several variations thereof. This discussion should not be construed as limiting the invention to that particular embodiment or to those particular variations. Practitioners skilled in the art will recognize numerous other embodiments and variations, as well.

With reference to the Figures, the present invention is directed to a lightweight, reinforced brake drum 10 for use with vehicles requiring brakes (e.g., trucks, cars, etc.), for example, as part of a wheel assembly 13. The lightweight, reinforced brake drum 10 comprises (i) an inner member (wear plate) 14, (ii) a length of reinforcement wrapping or material (e.g., wire, cable, fiber or mesh) 16, and (iii) an outer shell 18.

The inner member (wear plate) 14 is tubular or generally tubular and has an interior surface 20 and an exterior surface 22. The interior surface 20 has a surface finish which is suitable for contacting brake pads 24. Preferably, the surface finish is at least about one hundred twenty-five (125) microinches RMS.

Preferably, the inner member 14 comprises or is composed of a lightweight material having a density of less than about 0.15 pounds per cubic inch and having a high resistance to corrosive road conditions. Typically, the inner member 14 is composed of an aluminum or an aluminum alloy. Other lightweight materials and alloys, such as ceramic, magnesium and tinsalloy, can also be used in the invention, as can composite materials such as carbon fiber epoxy resin composites. For example, an alloy which includes at least about seventy-five (75) volume percent aluminum makes an excellent inner member 14. Preferably, the inner member (wear liner) comprises or consists of MMC, or the like. Preferably the inner member and the outer shell are made of conventional aluminum, aluminum alloy, or an aluminum-based metal matrix composite (MMC), comprising a particulate reinforcement (e.g., DURALCAN®, containing silicon carbide; manufactured by Alcan Aluminum Limited). Preferably, the outer shell and the inner member comprise at least one member of the 535-alloy family (ALCAN aluminum) selected from the group consisting of 535.0, 535.2, A535.0, A535.1, B535.0, B535.2. Preferably, an essentially Be (beryllium)-free alloy, such as A535 and B535 (low Mn) are used. Preferably, A535.1 is used. Alternatively, the inner member consists of, or comprises ceramic matrix composite (CMC); ‘carbon graphite foam’; or manganese-bronze having a particulate reinforcement such as, but not limited to silicon carbide (e.g., from about 10% to about 35%).

Preferably, the inner member comprises, or is substantially comprised of a friction material being a ceramic matrix composite (“CMC”) having a two- or three-dimensionally interconnected crystalline ceramic phase, and a non-contiguous metal phase dispersed within the interconnected ceramic phase (see, e.g., U.S. Pat. Nos. 5,620,791, 5,878,849 and 6,458,466, incorporated herein by reference in their entirety). The ceramic phase of the CMC may be a boride, oxide, carbide, nitride, silicide or combination thereof. Combinations include, for example, borocarbides, oxynitrides, oxycarbides and carbonitrides. The ceramic may include various dopant elements to provide a specifically desired microstructure, or specifically desired mechanical, physical, or chemical properties in the resulting composite. The metal phase of the CMC may be a metal selected from the Periodic Table Groups 2, 4-11, 13 and 14 and alloys thereof. In particular embodiments, the CMC is produced by infiltrating a porous ceramic body with a metal, thus forming a composite. Such infiltration involves, for example, forming a porous ceramic ‘preform’ prepared from ceramic powder, such as in slip casting (e.g., a dispersion of the ceramic powder in a liquid, or as in pressing (e.g., applying pressure to powder in the absence of heat), and then infiltrating a liquid metal into the pores of said ‘preform.’ In particular embodiments, the friction material comprises a ceramic-metal composite comprised of a metal phase and a ceramic phase dispersed within each other, wherein the ceramic phase is present in an amount of at least 20 percent by volume of the ceramic-metal composite. In particular embodiments, the braking component is a metal substrate, such as aluminum, having laminated thereto a ceramic metal composite of a dense boron carbide-aluminum composite having high specific heat and low density.

In particularly preferred embodiments, at least one of the tubular inner member, the bonding layer, and the outer shell comprises ‘carbon graphite foam’. Preferably, the inner member comprises ‘carbon graphite foam.’ Preferably, infusion casting is used in such embodiments. For example, an aluminum-based alloys (e.g., eutecic, hypereutectic, or otherwise), with or without particulate reinforcement are cast into (e.g., infiltration casting) a ‘preform’ of porous ‘carbon graphite foam’ (with or without particulate reinforcement, such as silicon carbide). Carbon graphite foam (developed at Oak Ridge National Laboratory, USA) has high thermal conductivity and also acts as super-conductor (see, e.g., U.S. Pat. Nos. 6,673,328, 6,663,842, 6,656,443, 6,398,994, 6,387,343 and 6,261,485, all of which are incorporated by reference herein in their entirety). Preferably the silicon carbide volume should be from about 10% to 35% to provide desired friction at wear plate rubbing surface. Infiltration of un-reinforced or reinforced alloy into carbon graphite foam ‘preform’ is during a suitable casting procedure including, but not limited to die casting, high-vacuum permanent mold casting, squeeze casting, or centrifugal casting. According to the present invention, carbon graphite foam can be included in the compositions of at least one of the tubular inner member, and any bonding layers, or other member or parts in contact therewith. Significantly, according to the present invention, inner members comprised of carbon graphite foam are more cost effective that CMC versions, and are environmentally favored because they are produced from a by-product of coal production.

Preferably, if the material predominantly forming the inner member 14 is relatively lightweight and soft (e.g., aluminum alloy), it is mixed with an abrasive so that the interior surface 20 of the inner member 14 has a coefficient of friction and wear resistivity similar to that of prior art brake drums 10 made from iron and steel. Typical abrasives usable in the invention are silicon carbide and carborundum. Where the inner member 14 is composed of an aluminum or aluminum alloy, the composition preferably includes between about ten (10) and about fifty (50) volume percent abrasive, or between about ten (10) and about thirty (30) volume percent abrasives, or between about ten (10) and about twenty-eight (28) volume percent abrasives. In preferred embodiments, the inner member 14 material contains between about fifteen (15) and about twenty-eight (28) volume percent abrasives. An excessive amount of abrasive material tends to make the inner member 14 brittle, while an insufficient amount of abrasive material causes the interior surface 20 to be slippery when engaging the brake pads 24 and the interior surface 20 tends to wear too quickly.

Where the abrasive material consists of or comprises silicon carbide particles, the particle size distribution preferably has a median diameter of between about ten (10) and about twenty (20) micrometers with less than about five percent (5%) of the particles larger than twenty-five (25) micrometers and with no more than about ninety percent (90%) of the particles larger than about five (5) or larger that about eight (8) micrometers. Silicon carbon particles which meet FEPA Standard 42-GB-1984 for F500-grit powders are preferably used in the invention.

Preferably, the inner member is comprises or consist of MMC, CMC or ‘carbon graphite foam’. A commercially available material known as “Duracon.RTM.”, marketed by Alcon Aluminum, Ltd., Duralcon U.S.A. of San Diego, Calif., is an excellent material for the inner member 14. Duracon.RTM. is a mixture of aluminum/ceramic and about eighteen-twenty-two volume percent (18-22%) of silicon carbide.

Casting Embodiments

Preferably, the inner member 14 is formed by a casting process and the interior surface 20 is optionally machined to obtain a finish suitable for contacting a brake pad(s) 24.

In particular embodiments, the MMC inner member is initially cast as MMC.

The outer member 18, and/or the inner member(s) (wear plates) 14 are preferably cast in a mold(s). The casting process is performed by any suitable casting process, including but not limited to die casting, sand casting, permanent mold casting, squeeze casting, or lost foam casting. Preferably, casting is by die-casting. Alternatively, casting of the outer member 18, and/or the inner member(s) (wear plates) 14 is by spin-casting, such as that generally described in U.S. Pat. No. 5,980,792 to Chamlee (incorporated herein by reference in its entirety). For example, aluminum-based metal matrix composite (MMC) comprising a particulate reinforcement (e.g., Duralcan®) containing silicon carbide) is centrifugally spin-casted to cause and create functionally beneficial particulate (sic) distributions (gradients). In the present instance such casting methods increase particle density at friction surfaces.

Alternatively, aluminum-based alloys, including eutectic and hypereutectic alloys such as 380, 388, 398, 413, or others such as 359-356-6061, optionally containing particulate reinforcement such as silicon carbide, or aluma oxides, ceramic powders or blends, can be cast into (e.g., by infiltration casting) a ceramic fiber-based, or a carbon graphite foam-based porous ‘preform’ of desired specification using discontinuous alumina-silicate (e.g., Kaowool Saffil Fibers), silicon carbide, ceramic powders, or blends of the preceding. Reinforced or non-reinforced aluminum-based alloys infiltrate the ‘preforms’ during the casting procedure, making, for example, a MMC with selective reinforcement. Preferably, casting process is performed by a suitable method, including, but not limited to die casting. Alternatively, permanent mold high-vacuum, squeeze casting, lost foam, or centrifugal casting (e.g., U.S. Pat. No. 5,980,792) can be employed.

In alternative preferred embodiments, the MMC inner member is provided by infiltration casting of molten aluminum alloy (the outer shell material) into a porous preform positioned within a die cast mold cavity for in situ casting. Preferably, the porous perform comprises or consists of silicon carbide and/or aluminum oxide that has been cast to form the porous preform. Preferably, the porous perform has the dimensions of the inner member, and has a porosity percentage of about 72% (corresponding to a particle percentage of about 28% in the final MMC inner member). Alternatively, the porosity percentage can vary between about 75% and about 50% (corresponding to a particle percentage of about 25% to about 50% in the final MMC inner member). The MMC in such embodiments is produced upon infiltration of the molten aluminum alloy into the pores of perform to provide for an MMC having the desired particle composition.

In alternate preferred embodiments, infusion casting is preferred where the inner member comprises ‘carbon graphite foam’. For example, an aluminum-based alloys (e.g., eutecic, hypereutectic, or otherwise), with or without particulate reinforcement are cast into (e.g., infiltration casting) a ‘preform’ of porous ‘carbon graphite foam’ (with or without particulate reinforcement, such as silicon carbide).

For typical brake drums 10 for use on a heavy-duty truck, the inner member 14 has an internal diameter 26 of about 16 1/2 inches, and a width 28 of about 7 inches. For the material sold under the Duracon.RTM. mark, a thickness 30 of the inner member 14 of between about 0.35 inches to about 0.60 inches provides sufficient internal yield strength and wear life when manufactured in accordance with this invention.

Reinforcement Material or Wrapping

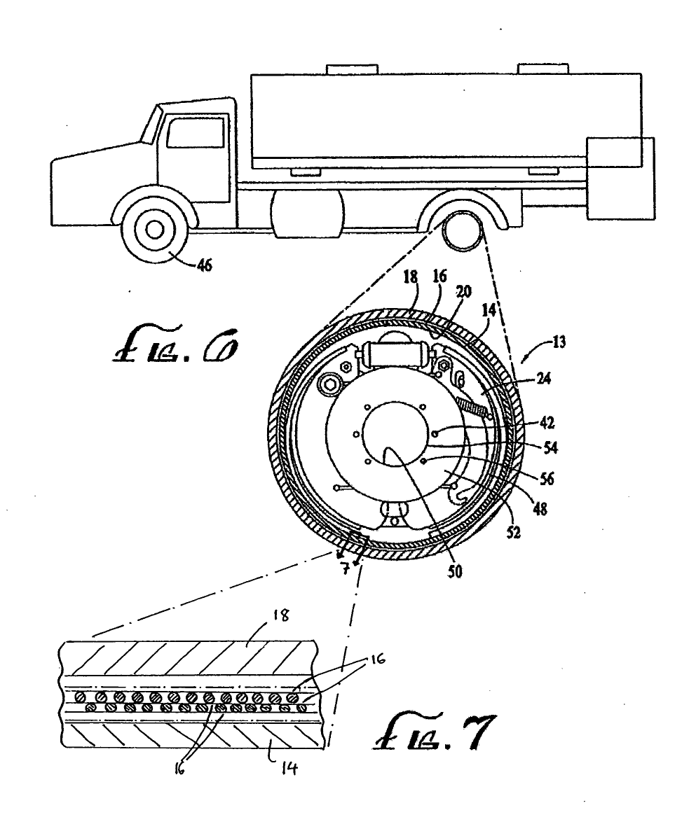

The length of the reinforcement material or wrapping (e.g., mesh, wire or multi-filament cable) 16 is wrapped around a portion of the exterior surface 22. In particular embodiments, multiple layers of the length of reinforcement wrapping (e.g., wire) 16 are wrapped around the entire exterior surface 22 to provide support for the inner member 14. As shown in FIGS. 2-5, multiple layers of a length of wire 16, for example, can be crisscrossed across the exterior surface 22 to provide better support to the inner member 14. With reference to FIG. 2, a first layer 31a of wire 16 is wrapped substantially straight around the inner member 14. With reference to FIG. 3, a second layer 31b of wire 16 is wrapped at about a ten (10) to thirty (30) degree angle from the first layer 31a. With reference to FIG. 4, a third layer 31c of wire 16 is wrapped at about a twenty (20) to sixty (60) degree angle from the second layer 31b. With reference to FIG. 5, a fourth layer 31d is wrapped substantially similar to the first layer 31a. The required overall thickness of layers of wire 16 depends upon the tensile strength of the length of reinforcement wrapping (e.g., wire cable, mesh, etc.) 16.

In a particular embodiment, a length of wire (or cable) 16 made of a steel alloy having a tensile strength of between about 180,000-240,000 psi and having a diameter 32 of between about 0.05 inches to about 0.25 inches is preferred since this wire can be tightly and consistently wrapped around the inner member 14. For the type of wire detailed above, multiple layers of wire (or cable) 16 having a combined thickness 34 of between about 0.1 inches to about 0.4 inches provides sufficient support for the brake drum 10. If an insufficient amount of wire 16 is wrapped around the inner member 14, the internal yield strength of the brake drum 10 is too low and the brake drum 10 tends to rupture from internal pressures exerted by the brake pads 24. If too many layers of wire are wrapped around the inner member 14, the internal yield strength is large, the brake drum 10 will be heavier than necessary.

Preferably, cable (wrapped multi-stranded wire) is used and only a single layer of wrappings is required.

Additional embodiments comprise a composite wire 16 consisting of an inner core and outer cladding with the core and cladding made of two different metals or metal allows. Preferably, one of the metals or metal alloys has low impedance (e.g., copper or copper alloy) and the other metal or metal alloy is one having high tensile strength (e.g., steel or steel alloy). In preferred embodiments the core is made of the metal or metal allow with high tensile strength and the cladding is made of the metal or metal alloy with low impedance.

According to particular aspects of the present invention, such wrappings are operable to interact with external activatable magnetic elements (e.g., electromagnets), fixed at one or more positions within a vehicle (e.g., truck) so as to be in electromagnetic association with the inventive drums to provide for additional braking (drag braking) when needed.

A different embodiment comprises a length of multi-stranded wire (preformed cable) 16, such as preformed aircraft cable or commercial grade low stretch cable having (7×19) seven bundles of nineteen separate wire strands, having a diameter between 0.062 inches to about 0.562 inches. Preferably, when cable is used, only a single layer of wrappings is required to support for brake drum 10.

The length of wire or multi-wire, preformed cable 16 is wrapped tightly around the exterior surface 22. Typically, the length of wire or multi-wire, preformed cable 16 is wrapped tightly to have a tension of at least five (5) foot-pounds. Preferably, the length of wire or multi-wire, preformed cable 16 is wrapped to have a tension of at least about twenty (20) to forty-five (45) foot-pounds to obtain the desired internal yield strength of the brake drum 10. Alternately, for a wire or multi-wire, preformed cable 16 having a tensile greater than 240,000 psi, the wire or multi-wire, preformed cable 16 can be wrapped to have a tension which approaches or exceeds about seventy-five (75) foot-pounds. The ends (not shown) of wire or multi-wire, preformed cable 16 can be welded (not shown) to the inner member 14 or to wire or multi-wire, preformed cable 16 to retain the tension on the wire or multi-wire, preformed cable 16.

In alternative preferred embodiments, the length of reinforcement wrapping comprises high-strength fibers, such as composite fibers, cable or mesh, including, but not limited to fibers, cables and arrays (e.g., mesh) comprising: carbon fibers, vitreous glass fibers (Basalt wool, comprising SiO₂, AI₂O₃, CaO, MgO and Fe₂O₃), alumina oxide fibers and e-glass (e.g., fiber glass), and combinations thereof. According to the present invention such fibers are used in, for example, wire, cable, and other arrays (e.g., mesh, or woven arrays) to provide reinforcement wrapping to support the inner member. Preferably, the reinforcement wrapping comprises material that is not flammable, and is not irritating to the eyes, skin and respiratory tract. Preferably, the fibers of the reinforcement wrapping are non-respirable, and non-hazardous. Preferably, reinforcement wrapping comprises vitreous glass (Basalt wool). Preferably, the vitreous fibers are amorphous comprising, as main constituents, SiO₂, Al₂O₃, CaO, MgO and Fe₂O₃, and no carcinogens are present in amounts above 0.1%. Preferably, the vitreous glass melts at about 2400 degrees Fahrenheit. Some advantages of Basalt-based fibers (vitreous glass, or pseudo-glass) are that they are relatively inexpensive, are approximately five-times stronger that steel on a weight basis, and have relatively lower thermal expansion coefficient-retaining strength above 400 degrees Centigrade. Additionally, and significantly, the Basalt-based fibers are much safer to work with, being non-carcinogenic and non-respirable.

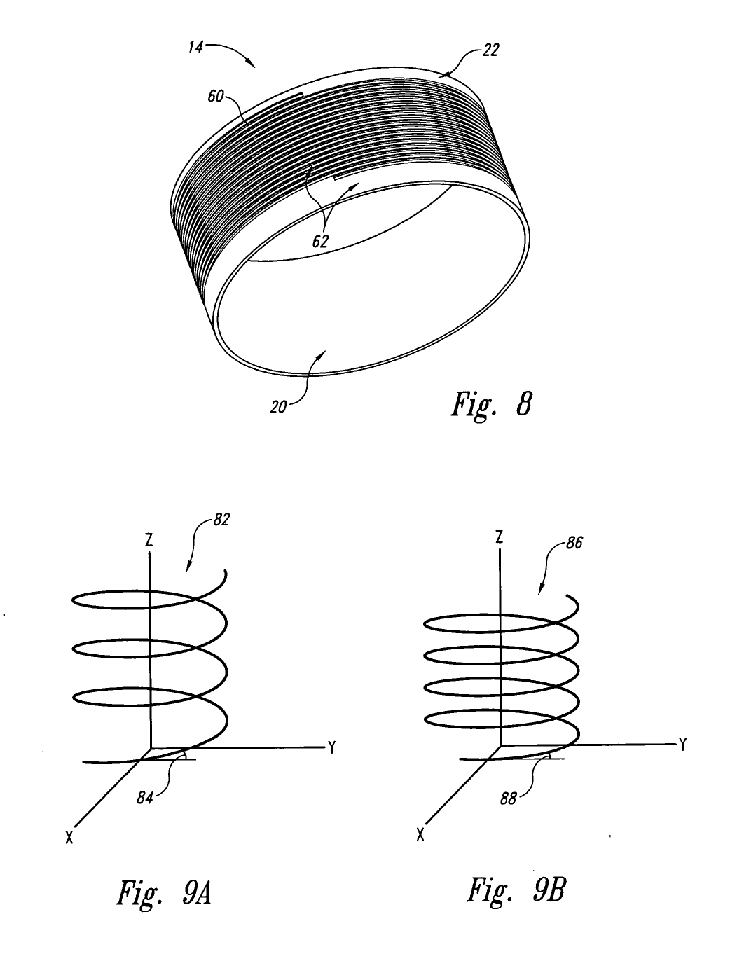

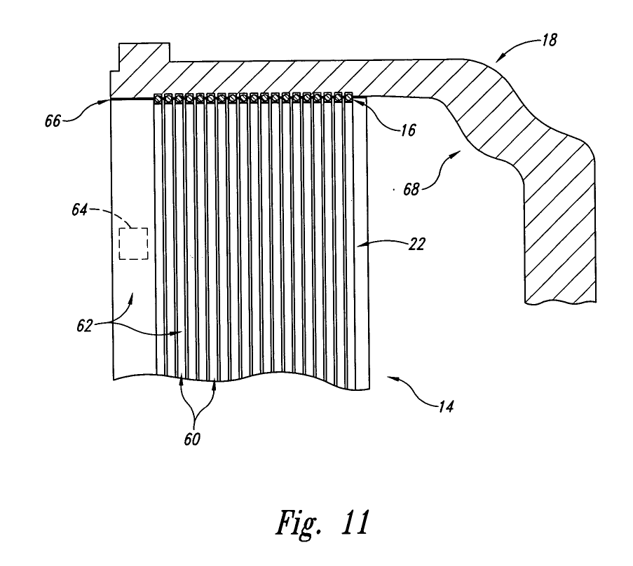

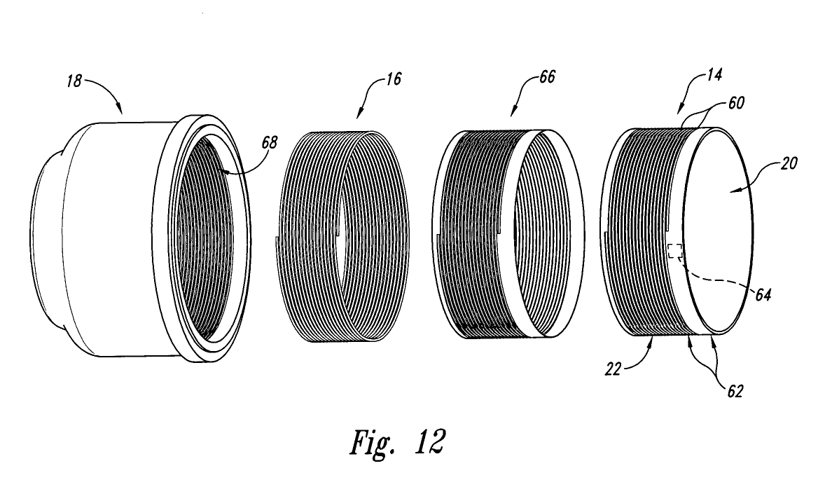

With reference to FIGS. 8 through 12, particular embodiments incorporate a generally continuous, circular, helical groove 60 on the exterior surface 22 of the inner member 14. Preferably, the groove 60 has depths ranging from 0.100 inches to 0.350 inches, as measured from the exterior surface 22 of inner member 14 to the bottommost point of groove 60. Preferably, groove 60 has widths generally ranging from 0.015 inches to 0.650 inches. Groove 60 forms spaces (or walls) 62 on the exterior surface 22 of the inner member 14, which run between the groove 60 and between the groove and the edges of inner member 14. Preferably, these spaces (or walls) 62 have widths ranging between 0.025 inches and 0.500 inches. By varying the pitch (see FIG. 9) of groove 60, groove 60 can run over different percentages of the exterior surface of inner member 14.

With reference to FIG. 9, it is well-known in the art that the “pitch” of a circular helix refers to the angle 84 that a helix makes with the plane perpendicular to the axis of the helix. The winding number is the number of turns a helix makes for a given interval along its axis. For a helix with a uniform pitch, the pitch and winding number are inversely proportional, that is, the lower the pitch (i.e., closer the pitch is to zero degrees) the higher the winding number. The helix 82 and helix 86 have different pitches 84 and 88. Because helix 86 has a lower pitch 88 than the pitch 84 of helix 82, helix 86 has a higher winding number than helix 82.

In alternative embodiments with reinforcement material or wrapping, comprising fiber arrays (e.g., carbon fibers, vitreous glass fibers (Basalt wool comprising SiO₂, Al₂O₃, CaO, MgO and Fe₂O₃), alumina oxide fibers and e-glass (e.g., fiber glass), and combinations thereof), the outer surface of the inner member may have a suitable alignment pattern cast into the outer surface thereof, the cast alignment pattern operatively complementary with the reinforcement material or wrapping to facilitate, for example, keeping the fiber arrays in a fixed position relative to the inner member.

Sensor Materials

Further embodiments incorporating a groove 60 or other alignment pattern on the exterior surface 22 of inner member 14, additionally incorporate sensor materials or devices (e.g., magnetic resistive devices or means, or heat transference devices or materials such as sodium metal) placed within receiving means such as, for example, recessed cavities 64 in the spaces (or walls) 62 between the groove 60 on the exterior surface 22 of inner member 14. These recessed means or cavities are suitably sized to accommodate sensor materials or devices. Preferably, the sensor material or device is at least one of a heat sensing material or device, a speed or motion sensing material or device, a vibration sensing material or device, or a pressure sensing material or device. Preferably, the heat sensing device or material is a thermal voltaic cell, or a thermal voltaic material, respectively.

In additional embodiments, the inner member 14 further comprises at least one recessed means or cavity 64 on its outer surface 22, wherein the cavity is sized to hold a heat transfer-enhancing material. Preferably, the heat transfer-enhancing material is metallic sodium.

In particular embodiments comprising a groove 60, a wire or multi-wire preformed cable 16 is wrapped tightly around inner member 14 such that the wire or multi-wire, preformed cable 16 lies within grove 60. By welding the ends of the wire or multi-wire, preformed cable 16 to the inner member 14, it is possible to get a single-layer wire wrapping that covers a substantial portion of the exterior surface 22 of inner member 14 and provides added strength to inner member 14.

In other embodiments, a reinforcement material or wrapping (e.g., a wire or multi-wire, preformed cable or mesh 16) is wrapped tightly around the inner member 14 such that the reinforcement wrapping lies within the groove 60. The wrapping (e.g., wire) is continued to be wrapped in a crisscross manner over previous layers. With reference to FIGS. 2-5, a first layer 31a of wire or multi-wire, preformed cable 16 is wrapped around inner member 14 so as to fit within a groove (not shown). With reference to FIG. 3, a second layer 31b of wire 16 is wrapped at about a ten (10) to thirty (30) degree angle from the first layer 31a. With reference to FIG. 4, a third layer 31c of wire 16 is wrapped at about a twenty (20) to sixty (60) degree angle from the second layer 31b. With reference to FIG. 5, a fourth layer 31d is wrapped substantially similar to the first layer 31a.

Other embodiments comprise a plurality of generally continuous, circular, helical grooves 60 on the exterior surface 22 of inner member 14 arranged generally parallel to one another. In these embodiments, multiple lengths of reinforcement wrapping (e.g., wire 16, multi-wire, preformed cables, mesh, etc., 16), or a combination thereof can be wrapped tightly around inner member 14 in a one-to-one correspondence with grooves 60 such that each separate length of reinforcement wrapping is contained within a groove 60 and each groove 60 contains, for example, a wire or multi-wire preformed cable 16.

After the reinforcement material or wrapping (e.g., mesh, wire, cable, etc.) 16 is wrapped around the inner member 14, the outer shell 18 is placed (e.g., cast) over the wire 16 to protect, for example, the wire 16 and provide additional strength to the brake drum 10. Typically, the reinforced inner member 14 is placed in a mold (not shown) and the outer shell 18 is molded around the exterior surface 22 and the reinforcement wrapping 16.

As described in more detail herein above, the outer shell 18 can be made from a number of lightweight materials such as 356-355 aluminum (see herein above for more detailed list). Alternately, the outer shell can be comprised of a lightweight material having a density of less than about 0.15 pounds per cubic inch with a high resistance to corrosive road conditions. For example, aluminum or aluminum alloys or other lightweight materials and alloys such as magnesium, tinsalloy can be used in the invention as well as composite materials such as carbon fiber epoxy resin composites.

In particular embodiments, an MMC inner member is initially cast as MMC.

In alternative preferred embodiments, an MMC inner member is provided by infiltration casting of molten aluminum alloy (the outer shell material) into a porous preform positioned within a die cast mold cavity for in situ casting. Preferably, the porous perform comprises or consists of silicon carbide and/or aluminum oxide that has been cast to form the porous preform. Preferably, the porous perform has the dimensions of the inner member, and has a porosity percentage of about 72% (corresponding to a particle percentage of about 28% in the final MMC inner member). Alternatively, the porosity percentage can vary between about 75% and about 50% (corresponding to a particle percentage of about 25% to about 50% in the final MMC inner member). The MMC in such embodiments is produced upon infiltration of the molten aluminum alloy into the pores of perform to provide for an MMC having the desired particle composition. Some substantial advantages of the perform method disclosed herein is that there is no problem of keeping particles (e.g., silicon carbide and/or aluminum oxide) suspended during casting of the inner member, and the provision of uniformity of particle distribution during casting.

Preferably, the outer shell and the inner member comprise at least one member of the 535-alloy family (ALCAN aluminum) selected from the group consisting of 535.0, 535.2, A535.0, A535.1, B535.0, B535.2. Preferably, an essentially Be (beryllium)-free alloy, such as A535 and B535 (low Mn) are used. Preferably, A535.1 is used. 535 alloys retain a bright physical appearance without deterioration in outdoor service. 535 alloys have high corrosion resistance and have superior aging properties (less fatigue).

In preferred embodiments, infusion casting is preferred where the inner member comprises ‘carbon graphite foam’. For example, an aluminum-based alloys (e.g., eutecic, hypereutectic, or otherwise), with or without particulate reinforcement are cast into (e.g., infiltration casting) a ‘preform’ of porous ‘carbon graphite foam’ (with or without particulate reinforcement, such as silicon carbide).

Preferably, the inner member 14 and the outer shell 18 are made of a material having similar rates of thermal expansion so that the inner member 14 and the outer shell 18 expand at the same rate to prevent separation of the inner member 14 and the outer shell 18.

Similar to prior art brake drums, the outer shell 18 is typically cylindrical shaped. For the version described herein, an outer shell 18 having a thickness 44 of between about 0.75 inches to about 1.25 inches is sufficient.

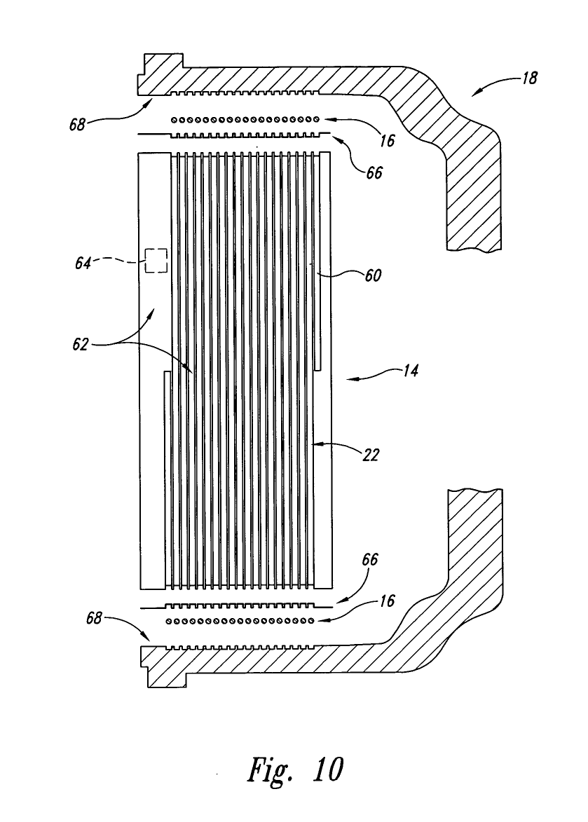

With reference to FIGS. 10-12, other embodiments comprise a bonding layer 66 preferably made of a metal alloy (e.g., 1100 aluminum) having a melting temperature lower than that of the material comprising either the inner member 14 or the outer shell 18. Bonding layer 66 is fused between the inner member and the layers of wire, or multi-wire, preformed cable 16. In other embodiments, a bonding layer (not shown) is fused between the layers of wire, or multi-wire, preformed cable 16 and outer shell 18. In yet other embodiments, a bonding layer 66 is fused between the inner layer and the wire wrapping and a second bonding layer (not shown) is fused between the layers of wire, or multi-wire, preformed cable 16 and the outer shell 18.

According to the present invention, the fused bonding layer permeates, at least to some extent into each of the first and second materials, thereby enhancing thermal conductivity between first and second materials.

Preferably, the bonding layer is 1100 aluminum of a thickness from about 0.005 to about 0.035 inches. Preferably, the bonding layer comprises a metal alloy (e.g., 1100 aluminum) having a melting temperature lower than that of either the material from which the inner member and the outer shell are made of or the material from which the wire is made of, and is preferably fused between the wire wrapped around the inner member and the outer shell. Preferably, the bonding layer is applied by flame spraying. Preferably the bonding layer is applied to the exterior surface of the inner member (including over the cast grooves), prior to wrapping of the wire or cable into the grooves. Alternatively bonding layers are applied to the exterior surface of the inner members, both before and after wrapping of the wire or cable.

Preferably, for bonding layers comprising 1100 aluminum and the like, the bonding layer also comprises an amount of zinc or tin suitable to confer enhanced bonding (most likely by lowering the melting temperature of the bonding layer). In alternative embodiments, the boding layer is an adhesive (e.g., high-temperature adhesive). Preferably, such adhesives are used in combination with, for example, ceramic matrix composite (CMC) wear plates or carbon graphite foam-based wear plates. Preferably, the bonding layers, whether fused aluminum based or high-temperature adhesive comprise one or more additional materials to enhance thermal conduction. Preferably, the material comprises ‘carbon graphite foam.’

In particular embodiments, the bonding layer 66 is spray coated or dipped onto the wrapped layer or layers of reinforcement wrapping (e.g., wire or multi-wire, preformed cable, mesh, etc.,) 16. In other embodiments, the bonding layer 66 is cast as a thin shell over the layer or layers of, for example, wire or multi-fire, preformed cable 16, and is fused to the layer or layers of wire or multi-wire, preformed cable 16 and the outer shell 18, by casting the outer shell 18 in situ in a mold containing the inner member 14 tightly wrapped in wire or multi-wire, preformed cable 16 and a thin shell of the bonding layer 66.

Similarly, in embodiments comprising a bonding layer 66 between inner member 14 and the wire wrapping 16, the bonding layer 66 is spray coated or dipped onto the inner member 14 before the wire or multi-wire, preformed cable 16 is wrapped around inner member 14 (over bonding layer 66). In these embodiments, the bonding layer 66 could also be cast as a thin shell around inner member 14, which bonds to inner member 14 and wire wrapping 16 under the pressure of wrapping wire 16 around inner member 14 and from the additional heat and pressure of casting outer shell 18 in situ in a mold containing the inner member 14 with the thin shell of the bonding layer 66 and the wire 16 wrapped around both.

In embodiments where the reinforcement wrapping comprises Basalt fibers alumina oxide fibers, e-glass, composite fibers, etc., that are made into wire, cable or arrays (e.g., mesh), the reinforcement wrapping is preferably impregnated with 1100 aluminum dust to improve ‘wetting’ during the casting process.

In embodiments comprising a groove 60 or a plurality of grooves 60 on the exterior surface of inner member 14 and, for example, wire(s) or multi-wire, preformed cable(s) 16 tightly wound around inner member 14 so that they are contained with the groove(s) 60, the bonding layer 66 can be spray coated or dipped onto both the wire(s) or multi-wire, preformed cable(s) and the spaces (or walls) between the groove(s) 60.

In other embodiments, the bonding layer 66 can preferably be cast as a thin shell around an inner member 14 comprising a groove or plurality of grooves 60 containing, for example, wire 16; multi-wire, preformed cables 16; or a combination thereof, and fused into place by casting the outer shell 18 in situ in a mold containing the inner member, wires or multi-wire, preformed cables, and the thin shell of bonding layer 66 material.

In preferred embodiments, the bonding layer is preferably sprayed or dipped on to the outer surface 22 of the inner member 14 that incorporates a groove or plurality of grooves, or other reinforcement wrapping retention pattern 60 before the, for example, wire or multi-wire, preformed cable 16 is wrapped around the inner member 14 so as to fit within the groove or plurality of grooves 60.

In yet other embodiments, the bonding layer preferably comprises a thin shell 66 cast around the inner member 14, which has, for example, a groove or plurality of groove 60, before the wire or multi-wire, preformed cable 16 is wrapped around the thin shell 66 and the inner member 14. In these embodiments, the bonding layer 66 bonds to the inner member 14 and the wire 16 because of the pressure generated in wrapping the wire snuggly around the shell 66 and inner member 14 so that the wire fits within the groove or plurality of grooves 60. Bonding is further facilitated by casting the outer shell 18 in situ in a mold containing the inner member 14 which is surrounded by the thin shell bonding layer 66 and the wire wrapping 16.

Embodiments comprising a groove or plurality of grooves, or other reinforcement wrapping retention pattern cast 60 on the exterior surface 22 of inner member 14 have certain advantages. These include, without limitation, the wire or multi-wire, preformed cable 16 being securely held in place without the need for multiple layers of wire or multi-wire, preformed cable as illustrated in FIGS. 2-5. This allows for the use of less wire or multi-wire, preformed cable in the manufacture of the brake drums and also helps decrease the weight of the brake drum. For example, by allowing the wire or multi-wire, preformed cable 16 to be held in position by the groove or plurality of grooves 60 with gaps between the wire or multi-wire, preformed cable 16, the groove or plurality of grooves allow for a more uniform contact between the outer surface 22 of inner member 14 and inner surface 68 of the outer shell 18. More uniform contact facilitates greater thermal and acoustic transfer between inner member 14 and outer shell 18, which in turn reduces brake noise and helps prevent degradation of the inner member 14 from overheating.

The grooves or plurality of grooves, or other reinforcement material/wrapping retention patterns 60 also aid in the even spacing of wire 16; multi-wire, preformed cable 16; or a combination thereof. Even spacing aids in ease of manufacture of the brake drums. The uniform spaces between the wires or multi-wire, preformed cables 16, also facilitates thermal and acoustic transfer. In particular embodiments, the depth of the groove or plurality of grooves 60 and the diameter of the wire or multi-wire, preformed cable 16 is suitably adjusted so that some portion of the wire or multi-wire, preformed cable 16 extends beyond the outer surface 22 of inner member 14. This arrangement helps the outer shell 18 to “grip” the inner member 14 and prevents the inner member 14 slipping or turning within the outer shell, without the need for cast interfacing ridges or spines to lock the inner member 14 to the outer shell 18 (see, e.g., U.S. Pat. No. 1,989,211). The use of grooves 60 and wire or multi-wire, preformed cable 16 to help “lock” the inner member 14 and outer shell 18 together, leads to much simpler and cost-effective methods of manufacture than when the inner member and outer shell have ridges and spines.

Embodiments incorporating a bonding layer 66 of some metal alloy (e.g., 1100 aluminum) that has a lower melting temperature than the material used to manufacture inner member 14 and outer shell 18 have certain advantages. The advantages include, without limitation, increased thermal and acoustic transfer from the inner member 14 to the outer shell 18. This aids in decreasing brake noise and helps prevent the degradation of the inner member 14 due to overheating. The use of a bonding layer 66 also enhances the bond between the inner member 14 and outer shell 18, thus negating the need for ridges and spines to “lock” the inner member 14 and outer shell 18 together. This allows for simpler and more cost-effective methods of manufacturing these brake drums.

Preferably, the bonding layer comprises or is formed of 1100 aluminum. Preferably the thickness of the 1100 aluminum bonding layer is from about 0.005 to about 0.035 inches.

In alternate embodiments, particularly those having inner members comprising or consisting of CMC (or carbon graphite foam), the bonding layer may comprise or consist of epoxy.

The brake drum 10 includes at least one fastener 42 for securing the brake drum 10 to a portion of the wheel assembly 13. In FIG. 6, each wheel assembly 13 includes a wheel 46, a brake assembly 48, and an axle 50 and a wheel mounting pad 52 having a guidance ring 54 and a plurality of wheel bolts 56. Similar to prior art brake drums, the outer shell 18 can include a front surface 36 having a plurality of guidance bolt apertures 38 and a guidance ring aperture 40 extending there through. The wheel bolts 56 extend through bolt apertures 38 and a guidance ring 54 extends through the guidance ring aperture 40 to secure the brake drum 10 to the wheel assembly 13. Alternatively, the front surface 36 could be manufactured as an integral part of the inner member 14 or the brake drum 10 could be attached to the wheel assembly 13 in another fashion.

The invention provides an unusually light brake drum 10 which is comparable to typical brake drums made of steel in terms of internal yield strength, durability and braking power. Compared to typical heavy-duty truck brake drums which weight approximately one hundred twenty (120) pounds, an equivalent brake drum embodiment of the present invention having an inner member 14 made of an aluminum alloy/abrasive composition having a thickness of about 0.50 inches, multiple layers of wire 16 having an overall thickness 34 of about 0.3 inches and an aluminum alloy outer shell 18 having a thickness of about 1.25 inches weighs between about forty (40) pounds and about seventy-five (75) pounds. Accordingly, with a heavy-duty semi trailer rig, having four brake pads on the cab and four brake drums on the trailer, an increase in cargo handling capability of between about three hundred sixty (360) pounds and about six hundred forty (640) pounds can be realized. Such increase in cargo capacity can greatly affect the trucker's net profit.

Different sized brake drums are within the scope of the present invention, including those suitable for automobiles, SUVs, light trucks, medium duty trucks (e.g., class 7) and heavy duty trucks (e.g., class 8), and larger. In preferred embodiments the drums are sized to be used in association with lift-axels.

Secondary Brakes (e.g., Drag-Type Brakes)

Compression brake means (e.g., ‘Jake’ brakes, and exhaust compression brakes) are known in the art as secondary engine brakes, but are disfavored because they are noisy and can produce a stand-off condition with exhausted unburned fuel (exhaust valves are held open in the case of Jake brakes). Such means are relatively heavy.

Additionally, electromagnetic drive-line break means, or magnetic brakes, are known, where such breaks comprise mounted magnetic means placed, for example, behind a transmission and in communication with iron plates spinning at drive shaft speed. Such means are also relatively heavy.

A fundamental disadvantage of Jake breaks, exhaust compression brakes, or magnetic drive-line devices (aside from excessive weight, complexity and in some instances pollution), is that any drag produced thereby is transferred only to the drive axel, or to a set of dual drives, and not to all wheels. Therefore, there is a pronounced need in the art for additional means to provide secondary braking in the trucking industry.

In preferred embodiments of the present invention, electromagnetic means are used to produce/induce a pattern field or Eddy current in optimally arrayed communication with (e.g., placed ‘in shear’ with) the rotating inventive drum, so that the induced field current opposes the motion direction of the brake drum (or a brake disk) providing a drag brake (e.g., secondary drag-brake). Such means are relatively light. Such means would not be possible using conventional iron drums.

Preferably, for such purposes the drum comprises magnetic elements or particles, and the pattern field is in communication with said magnetic elements or particles to provide for an enhanced drag brake (e.g., secondary drag-brake).

Preferably, the present inventive drag breaks are positioned on each wheel end, and have independent control as to the amount of drag provided for each brake, and additionally interface with the ABS system of the vehicle (e.g., car, truck, trailer, etc.), providing an increased level of safety from skids, jackknifing, etc, and providing enhanced control.

Preferably, such brakes are additionally designed to be ‘regenerative’ to provide a source of electricity for vehicular reuse, and reduction of parasitic alternator drag, etc., to enhance efficiency and economy.

While the present invention has been described in considerable detail with reference to certain preferred versions, other versions are possible. Therefore, the spirit and scope of the appended claims should not be limited to the description of preferred versions contained herein.

1. A brake drum comprising:
(a) a tubular inner member having an exterior surface and an interior surface suitable for directly slidingly contacting a brake pad, the inner member being formed of a first material and comprising a reinforcement retention pattern on the exterior surface thereof;
(b) a reinforcement material in complementary communication with the reinforcement retention pattern, the reinforcement material being formed of a second material; and
(c) a tubular outer shell molded or cast over and covering or substantially covering the reinforcement material, the tubular outer shell comprising means to enable securing at least a portion of a wheel assembly to the brake drum, the outer shell being made from a third material, wherein the first material has a density less than that of the second material, and the second material has a strength greater than the first material.

2. The brake drum of claim 1, further comprising a bonding layer applied to the exterior surface of the inner member prior to application of the reinforcement material.

3. The brake drum of claim 2, wherein the bonding layer has a melting temperature that is at least one of: below that of the first and second materials; and below that of the first, second and third materials.

4. The brake drum of claim 2, wherein the bonding layer is 1100 aluminum (or epoxy).

5. The brake drum of claim 1, wherein the reinforcement material is selected from the group consisting of wire, cable, fibers, mesh, and combinations thereof.

6. The brake drum of claim 1, wherein the reinforcement retention pattern comprises a generally helical groove.

7. The brake drum of claim 1, wherein the inner member comprises at least one material selected from the group consisting of a aluminum-based metal matrix composite (MMC) with a particulate reinforcement, ceramic matrix composite (CMC), and carbon graphite foam.

8. The brake drum of claim 7, wherein the inner member is formed of carbon graphite foam.

9. The brake drum of claim 1, wherein the reinforcement material comprises at least one layer of a wrapped length of reinforcement material selected from the group consisting of wire, cable, fibers, mesh, and combinations thereof.

10. The brake drum of claim 1, wherein the reinforcement material comprises a low-impedance material.

11. The brake drum of claim 10, wherein the low-impedance material is copper.

12. A vehicle utilizing at least one brake drum according to claim 1.

13. A method of manufacturing a brake drum according to claim 1, comprising infiltration casting into a porous preform, the preform comprising a material selected from the group consisting of MMC, carbon graphite foam and combinations thereof.

14. The method of claim 13, comprising use of a die casting mold cavity.

15. A method of manufacturing a brake drum according to claim 1, comprising the use of at least one casting method selected from the group consisting of die casting, sand casting, permanent mold casting, squeeze casting, lost foam casting, and infiltration casting.

16. The brake drum of claim 2, wherein the inner member comprises at least one recessed cavity in the outer surface thereof, the cavity sized to hold a sensor device or sensor material in a position adjacent, or substantially adjacent to the bonding layer.

17. The brake drum of claim 16, wherein the sensing device or sensing material is at least one device or material selected from the group consisting of a heat sensing device or material, a speed or motion sensing device or material, a vibration sensing device or material, a wear sensing device or material, and a pressure sensing device or material.

18. The brake drum of claim 17, wherein the heat sensing device or material is a thermal voltaic cell, or a thermal voltaic material, respectively.

19. The brake drum of claim 2, wherein the inner member comprises at least one recessed cavity in the outer surface thereof, the cavity sized to hold a heat transfer-enhancing material in a position adjacent to the bonding layer.

20. The brake drum of claim 19, wherein the heat transfer-enhancing material is at least one of metallic sodium, and carbon graphite foam.
